(19) United States
(12) Patent Application Publication
(10) Pub. No.: US 2001/0049637 A1
(43) Pub. Date: Dec. 6, 2001

(54) System and method for providing an event-based community

(76) Inventor: Kevin Tso, San Jose, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/850,913

(22) Filed: May 7, 2001

Related U.S. Application Data
(60) Provisional application No. 60/203,225, filed on May 5, 2000.

(51) Int. Cl. G06F 17/60

(52) U.S. Cl. 705/26

(57) ABSTRACT

A system and method for producing electronic invitations and for storing event information including receiving invitation information from a first user, the invitation information including information about an event and about recipients of the invitation, storing invitation information in a database, sending invitation information to the invitation recipients, and receiving from at least one of the invitation recipients a response to the invitation.

### CROSS-REFERENCE TO RELATED APPLICATION(S)

This application claims priority of U.S. provisional application No. 60/203,225, filed on May 5, 2000, entitled EVENT-BASED COMMUNITY, the entire contents of which are hereby incorporated herein by reference.

### BACKGROUND OF THE INVENTION

This invention relates to a system and method for electronic invitations, and more particularly, to a system and method for managing invitations, responses, and events over the Internet.

Presently, if a person wishes to invite individuals or businesses to an event, the person must manually coordinate the invitations either using traditional mail, or using electronic mail. The user must also manually track positive and negative responses to the invitations. Filling out invitations can often be very time consuming and repetitive. This can be especially frustrating for a host who hosts many events for the same people.

Frequently, many of those invited do not respond. This is because responding is not always a simple matter. For example if the invitation is through traditional mail and requests a mailed reply without a stamped reply card the recipient of the invitation must procure proper postage. If getting a finite number of attendees is important, the person hosting the event must contact all of those invitees who have not responded, which can be a very time consuming task.

Often those who accept an invitation forget about the event. It would be advantageous to remind invitees, who have accepted their invitation, that the event is coming.

Once an event is over, if the attendees or the host wish to communicate with other attendees, they must have made personal contact with the other attendees. If a person took photographs of the event that they want to share with other attendees, the person must forward those pictures to each attendee separately through traditional mail or e-mail. It would be advantageous to provide a way for party attendees and others to share comments and photographs with other attendees and others without having to make personal contact with each other person.

### SUMMARY OF THE INVENTION

A system and method for producing electronic invitations and for storing event information is disclosed. In an embodiment, invitation information is received from an event host, including event information and invitation recipient information. Event, invitation, and recipient information is stored in a database. Invitations are sent to the designated invitation recipients and responses are received from the recipients.

In an embodiment, the event host submits a question to be asked of the plurality of recipients. The question is sent to one of the invitation recipients. A response to the question is received from the invitation recipient. The question is modified for the remaining invitation recipients depending on the response received.

In an additional embodiment, the host and recipients can submit photographs about the event. Submitted photographs are stored in a database and shown in response to later event information requests from the host and recipients. In another embodiment, the host and the recipients are prompted to enter a comment regarding a photograph of an event. Any comments received about the photograph are stored in a database and shown in response to later event information requests from the host and recipients. The host of the event may select which of the recipients may view event information. If the host selects a subset of recipients to receive event information, then event information will only be given in response to event information requests from one of the subset of recipients.

A user may be sent a list of events that they either hosted or were invited to. The user is then prompted to select an event from the list of events to receive more information about. Once the user selects an event from the list of events, the user is sent information about the event that they selected. The information sent to the user may include a list of invitation recipients, photographs about the event, and comments about photographs.

In an additional embodiment, an event host is prompted to create a gift registry for an event corresponding to an invitation. If the user elects to create a gift registry, then gift registry information is received from the user. If a gift registry is created, then invitation recipients are prompted to purchase a gift for the user from the gift registry.

As part of the invitation design, the host is prompted to select attributes for the invitation. The attributes that the user may select from include text font, text size, text color, text, background color, graphics, sound, and video. Once the invitation attributes are received from a user, the attributes are stored in a database.

In an embodiment, a reminder letter is sent to invitation recipients for which a positive response has been received. In another embodiment, an additional response request is sent to recipients for which no response has been received.

In yet another embodiment, the information about the event received from the user includes the physical location of the event. Additionally, the information received from the user about each recipient includes the physical location of the recipient. Directions are generated from each recipient's physical location to the physical location of the event. The directions are stored in a directions database. The directions are sent to each recipient along with the invitation.

A system for producing electronic invitations according to an embodiment of the invention has a database coupled to a computer network for storing information about invitations, recipients, responses, and events. The system also has a server coupled to the computer network. The server is configured to receive event information from an event host, prepare invitations to the event, send the invitations to invitation recipients, and receive responses from the recipients. Additionally, the server may be configured to send a notification of an invitation to the recipients prompting the recipients to view their invitation. When recipients request their invitations, then the invitation text and any questions posed by the host are sent to the recipient. Therefore, the answers to the questions by recipients who previously requested their invitations may be used to modify the question for later requesters. In a preferred embodiment, the computer network is the Internet.

### BRIEF DESCRIPTION OF THE DRAWINGS

A further understanding and appreciation for the present invention will now be had in conjunction with the following drawings and detailed description wherein:

FIG. 1 is an overview of a system for an event-based community according to an embodiment of the present invention;

FIG. 2 is an overview of the hardware used to create an event-based community according to an embodiment of the present invention;

FIG. 3 is a flow chart showing the options presented to a member of an event-based community according to an embodiment of the present invention;

FIG. 4 is a flow chart showing the process of invitation creation according to an embodiment of the present invention;

FIG. 5 is a diagram showing hosts and invitees in relation to past events; and

FIG. 6 is a flow chart showing the options presented to an invitee responding to an invitation according to an embodiment of the present invention.

### DETAILED DESCRIPTION OF THE INVENTION

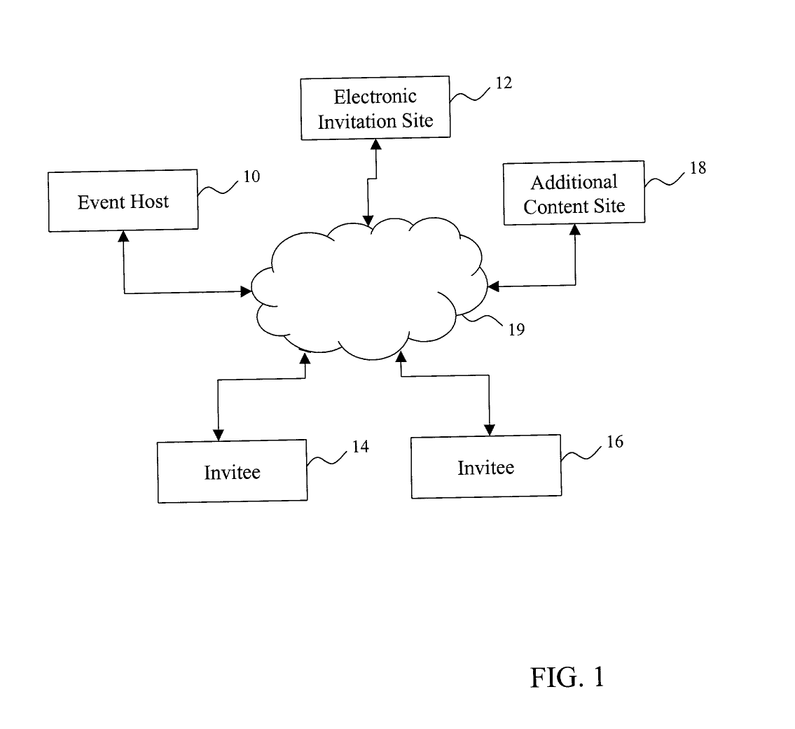

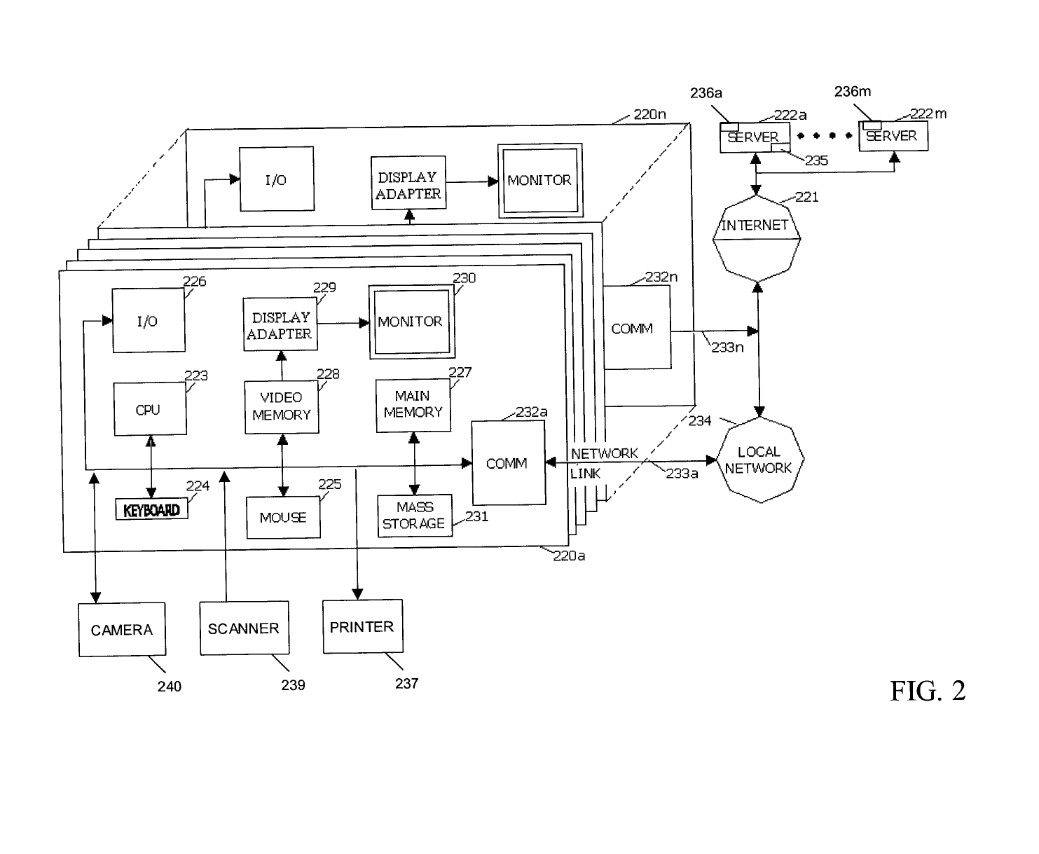

A system for creating event-based communities in accordance with an embodiment of the present invention is illustrated in FIGS. 1 and 2. An event host 10 contacts an invitation site 12. Once at the invitation site 12, the host 10 generates an invitation and designates invitees 14, 16 to the event. At a predetermined time specified by the host, the invitation site 12 sends electronic invitations to the designated invitees 14,16. The invitees 14, 16 open Internet browsers and point their browsers to the invitation site 12. The invitation site 12 communicates with the invitees 14, 16 to allow the invitees 14,16 to respond to the invitation and to become members of the event-based community. A portion of the content provided to the event host 10 and the invitees 14,16 may be provided by a third party content provider which communicates with the invitation site 18. All of the different parties communicate through a remote communication interface 19. In an embodiment of the present invention, the remote communication interface is the Internet.

The event host and the invitees use user devices to access the invitation site, as shown in FIG. 2. The system of FIG. 2 has multiple user devices 220a-220n coupled to an invitation site 222a-222m through one or remote communication interfaces. In the embodiment described, the remote communication interface comprises the Internet, although in alternative embodiments the remote communication interface comprises an Intranet or other computer to computer interface.

The Internet has recently been popularized by the rapid success of the World Wide Web (WWW or Web). The Web links together a variety of computers from around the world and various topics in a non-sequential web of associations which permit a user to browse from one topic to another, regardless of the format and order of topics. Users access and browse the Web using a web browser that generally resides and is executed on the user's computer. Commercially available web browsers such as Netscape's Navigator™ and Microsoft Internet Explorer™ are very common and accessible by personal computer (PC) users. The web browser allows a user to retrieve and render hyper-media content from the network of computers within the Web, including text, sound, video and other types of data. These hyper-media contents are stored on different web sites.

Web sites are locations on server computers that are accessible through the Internet. A variety of information, such as hyper media content and databases can be stored on a web site and be accessed by users with computers connected to the Internet. One of the applications of the Web is its capability to link a web site with a database so that users can search for information. In essence, the web site becomes the user interface (UI) for database applications enabling a user to select search criteria and execute searches of a database that resides on a remote computer. To serve up pages, web sites need a server (a host computer) and server software that runs on the Server. The host computer manages the communication protocols and houses the pages and related software required to create a web site on the Internet. Host computers spread throughout the Internet can house different web sites.

The Internet works based on a client/server model. In this model, a client computer communicates with a server computer on which information resides and the client computer depends on the server to deliver requested information and services. These services may involve searching for information and sending it back to the client, such as when a database on the Web is queried. Other examples of these services are delivering web pages through a web site, and handling incoming and outgoing e-mail. Typically, the client is a PC user using a browser to connect to and search the servers. The servers (also known as hosts) are usually more powerful computers that house the data and databases. The client/server model enables the Web to be conceived of a limitless file storage medium distributed among thousands of host computers, all accessible by any individual PC user.

The web site and the hosts that make up the World Wide Web need to have unique locations so that a client computer can locate and retrieve information and web pages. For example, the unique identifier for a host computer is called IP (Internet Protocol) address and the unique identifier for a web site (web page) is called the URL (Uniform Resource Locator). A URL indicates where the host computer is located, the location of the web site on the host, and the name of the web page and the file type of each document, among other information.

Home and small business users connect to the Internet through Internet service providers using modems and common telephone or cable networks. Although, wireless and satellite connections are also possible. Larger businesses typically obtain access to the Internet through their private computer networks, using appropriate safeguards to prevent unauthorized access by outside parties to a company's private network.

FIG. 2 shows a block diagram of a typical Internet client/server environment used by the users and server in one embodiment of the present invention. The user devices 220a-220n used by the users are connected to the Internet 221 through the communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by user devices 220a-220n. In one embodiment of the present invention, a database for storing information about events resides on at least one of the servers 222a-222m and is accessible by users using one or more of the user devices 220a-220n to create an invite, to respond to invites and to create and view event content.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more user devices 220a-220n may be connected to a local network 234. An Input/Output (I/O) device 226 reads data from various data sources and outputs data to various data destinations. Optionally, one or more of the user devices 220a-220n may include a printer 237 for printing receipts and photographs, a scanner 239 for scanning pictures, and a digital camera 240 for providing video and pictures. In alternative embodiments of the present invention, a user device may be, for example, a personal digital assistant, a set-top box, and a cellular phone.

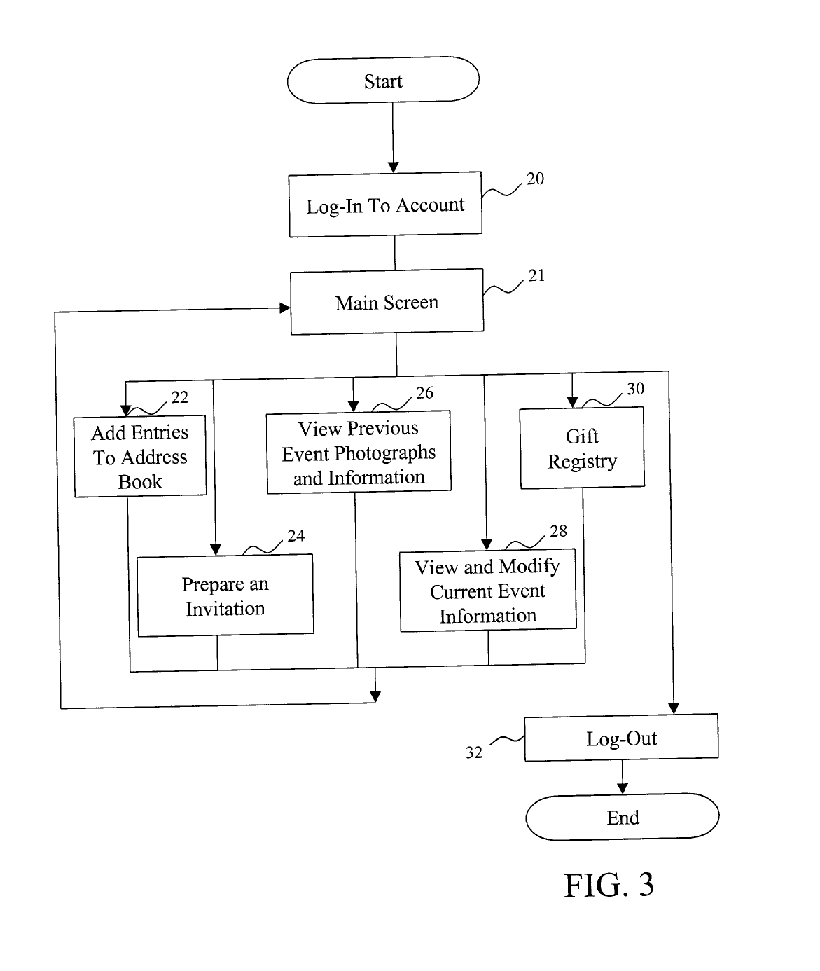

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 236a-236m, such as a hard disk, a CD drive, or a DVD for loading computer software. When a software such as the software responsible for executing the processes in FIGS. 3 to 6 is loaded on the server 222a, an off-the-shelf web management software or load balancing software may distribute the different modules of the software to different servers 222a-222m. Therefore, in one embodiment, the computer program responsible for executing the present invention resides on one or more servers.

Databases to carry out the processes of FIGS. 3 to 6 can be created, maintained and edited in many different types of database software including Access, FoxPro, and Oracle. In one embodiment of the present invention the database software is SQL Server 7.

An exemplary web site location 235 is shown on server 222a in FIG. 2. The web site 235 is the UI for accessing the databases described below. The web site 235 has a unique address that is used by the users to access server 222a (in this example) and the web site location on the server 222a. The computer software for executing the processes of the present invention may also reside on the web site 235.

Initially, a user not responding to an invitation, such as an event host, contacts the invitation site 12 and requests information using an Internet browser. In response to this request, the invitation site 12 sends a log-in screen 20 to the user. The log-in screen prompts the user to enter a user name and password if they have opened an account on the invitation site. The log-in screen also prompts the user to open a new account if they do not already have one.

If the user elects to open a new account, the user presses a button on the log-in screen. The button generates a request to the invitation site to open a new account. The invitation site then sends a new account sign-up screen to the user. The new account sign-up screen prompts the user to enter a user name and password. In an additional embodiment of the present invention, the new account screen also prompts the user to enter personal information such as their e-mail address, physical address, preferences, age, and sex. Once the user enters the appropriate information and sends the appropriate information to the invitation server, an account is opened for the new user and the user is transferred to a main menu discussed below.

If the user indicates that they are currently a member on the invitation site by entering a user name and password and pressing a log-in button on the log-in screen, then the user name and password entered by the user is sent to the invitation server 12. The invitation server checks the user name and password against user names and passwords stored in a database of members to ensure that the person is a current member. If the user name and password are found in the database, then the user is sent a main screen that presents the user with several different options as described below. Otherwise, the user is returned to the login screen.

In an embodiment, after the user has unsuccessfully attempted to log-in three times, the user is prompted to have their password e-mailed to the e-mail address that they provided when they registered. If the user does request this, then the user's is prompted to enter their username. If the username is found in the database, then the password is forwarded to the e-mail address saved in the database for the user name. Alternatively, if the user name is not found in the database, then the user is informed that the user name was not found, and prompted to either attempt to enter their user name again or open a new account.

In an additional embodiment of the present invention, once a user is logged into the system, a timer is started that is reset every time the invitation site receives a response from the user. If a time interval greater than a preselected time interval occurs between responses from a user, then the user is returned to the log-in screen. This prevents a user from leaving a user terminal without logging out of the invitation site, which may allow another individual to have access to the user's account.

Once the user has logged in, the user is sent a main menu screen 21 that provides the user with the option to view and add entries to an address book 22, prepare an invitation 24, view previous event photographs and information 26, view and modify current event information 28, set up a gift registry 30, and logout of the invitation site.

In an embodiment of the present invention, the user is only provided with those choices that make sense in light of their previous history. For example, a user who did not host and was not invited to any previous events is not prompted to view previous event photographs or information. Likewise, a user that does not have any current events pending, is not prompted to view and modify current event information.

If the user chooses to access their address book, then the user selects the view address book option from the main screen. Once the invitation server receives the request to view the address book, the invitation server generates and forwards to the user an address book screen. On the address book screen, the user is prompted to add new entries to the address book and modify current entries in the address book. In an embodiment, if the viewer does not have any entries in the address book, then the user is only prompted to add new entries.

If the user chooses to add a new entry into the address book, then the user selects the “add new entry” option from the address book screen. The invitation server generates an add new address book entry screen. The add new address book entry screen prompts the user to enter personal information for the new addressee, including, for example, the name, e-mail address, and physical address of the new entry.

In addition, the user is prompted to categorize the new entry into one or more of several categories. By categorizing the entries in the address book, the user can simply invite an entire category of people to the event. An address book entry may be categorized into multiple different groups. Once the user enters the personal information for the new addressee and sends it to the invitation server, the invitation server generates a database record for the addressee that is linked to the user.

If the user chooses to modify current address book entries, then the user selects the “modify current address book entry” option from the address book screen. Upon receipt of the user's selection to modify a current address book entry, the invitation server generates a modify address book entry screen containing all of the current address book entries. In an embodiment, the list is organized alphabetically by the last name of each address book entry. The user is prompted to select an address book entry for modification.

Once the invitation server receives a selection of an address book entry to modify, the invitation server generates an address book entry page containing the current information of the selected address book entry in a format that can be modified by the user. The user is then prompted to alter information about the current address book entry. The user is also prompted to delete the particular address book entry. Any changes made to the address book entry, or the deletion of the address book entry, are received by the invitation server and saved to an address book database linked to the user.

Once a user has completed viewing and modifying their address book, the user is returned to the main menu.

Preparing an Invitation for a New Event

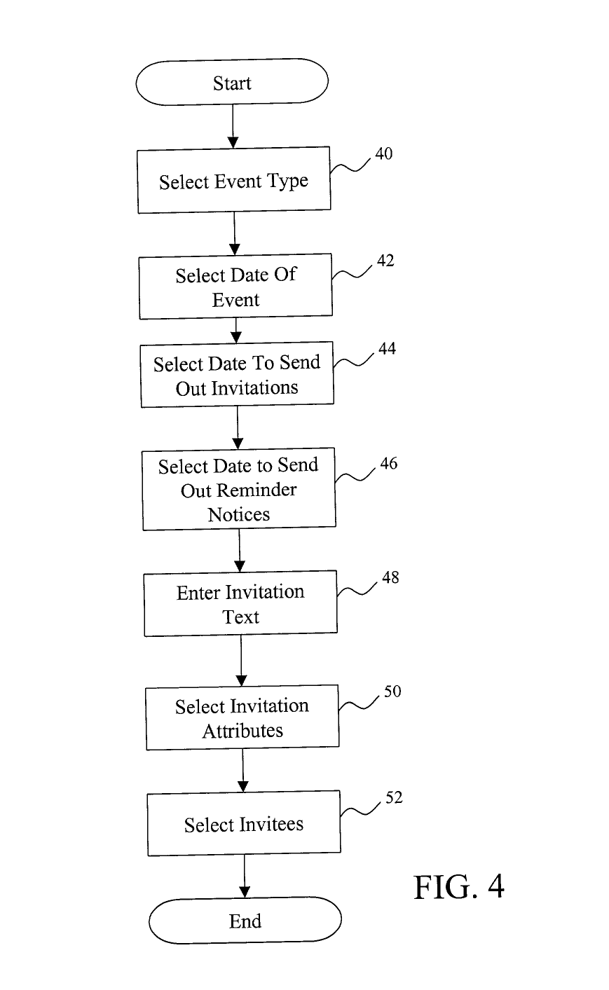

If, from the main screen, the user elects to prepare an invitation for a new event, then the user is forwarded to a prepare invitation screen. Once the user has elected to prepare an invitation, the user follows the sequence of events shown in FIG. 4. The prepare invitation screen prompts the user to select an event type from a list of event types, or to create a new event title (Box 40). In an embodiment of the present invention, the list of events that the user is prompted to choose from includes birthdays, anniversaries, parties, national holidays, baby showers, weddings, reunions, house warming parties, and meetings, although this list only represents a small fraction of the different types of pre-composed invitations that can be created for a user to select from. If the user selects to enter a new type of event, then the user is prompted to enter a title for the event.

Once a user has selected an event type, the user is prompted to select an event date (Box 42). In an embodiment of the present invention, the user is prompted to select the date by using pull-down menus for the month, the day and the year. In an alternative embodiment of the present invention, the user is prompted to type in a numerical value for the date by entering a number for the month, a number for the day, and a number for the year. In yet another alternative embodiment of the present invention, the system automatically recommends a date for those events selected that have a given date. For example, if the user has selected a Memorial Day barbecue as an event, the date of the event is preselected as the Memorial Day of the current year.

Once the date of the event has been selected, the user is prompted to select a date to send out invitations (Box 44). In an embodiment, the date is selected in the same manner as was the date of the event. In an additional embodiment of the present invention, the system preselects a date prior to the event for sending out invitations. In another embodiment of the present invention, the system is programmed to conform to etiquette rules in selecting the date to send out invitations.

Once the user has selected the event date and the date to send out invitations, the user is prompted to select a date to send out reminder notices (Box 46). In an embodiment of the present invention, the date to send out reminder notices is selected in the same manner as the date to send out invitations. In an alternative embodiment of the present invention, the invitation server is programmed to select a default reminder date, for example, one week before the event date.

Once the user has selected a date to send out reminder notices, the user is prompted to enter text that will appear on the inside of the invitation (Box 48). In an embodiment, the user is prompted to select one of a list of pre-composed text messages for the invitation. In an alternative embodiment of the present invention, the user is prompted to customize the text of each invitation based upon the characteristics of the recipient saved in the address book such as the sex of the recipient.

Once the user has entered text for the invitation, the user is prompted to select attributes of the invitation (Box 50). In an embodiment, the attributes that the user may choose from include the font, color, and size of the text, and the color of the background. The user is also prompted to download a picture to be used in the invitation. In an additional embodiment, the user is given the option of selecting from a list of clip art images to place on the invitation. In another embodiment, the user is prompted to generate a voice message to accompany the invitation. Additionally, the user is prompted to enter music or video to accompany the invitation.

In an embodiment, the user is prompted to create questions for the invitees. For example, if the event is a potluck, the user is prompted to generate a list of food items, that each invitee will be prompted to select from when they reply. The questions asked of each invitee may be dynamic depending on the responses of other invitees. For example, as a food item on the potluck list is selected by an invitee when they respond in the affirmative, that food item would be taken off of the list for later responding invitees. In an embodiment, dynamic questions may be created because the text of the invitation is generated whenever an invitee opens their electronic mail. Therefore, invitees who respond to the invitation and the question at a first point in time alter the question for those invitees who open their e-mailed invitation at a later point in time.

In an additional embodiment, the user is prompted to provide directions to the event. The user may provide a map by using a third party map provider such as Mapquest. In an embodiment, the map is saved as a picture and embedded in the invitation. In another embodiment, the map is dynamically created by the map provider and built into the invite as the invitee opens the invitation. In an additional embodiment, the map provides directions to each invitee whose physical address is known, by providing the event address and the invitee address to a direction provider. The direction provider, in turn, creates customized driving directions and a map from the invitee's address to the address where the event is taking place.

In an additional embodiment, the user is prompted to format the text and other attributes of the reminder that is to be sent to those attendees who indicated that they will be attending. The user is also prompted to create a different reminder to those who have not yet responded to the invitation by a certain date. In another embodiment, the user is prompted to select a separate date, besides the reminder date for urging people who have not responded to the invitation to do so.

Once the user has entered the invitation text and selected the invitation attributes, the user is prompted to select the invitees that the invitation will be sent to (Box 52). In order to facilitate the selection of invitees, the user is prompted to select invitees from an address book if the user has one. If the user elects to select invitees from their address book, the user is shown their address book with checkboxes placed next to each of the names in the address book. The user selects each person by checking off the checkbox next to the name in the address book and then presses a submit button. Once the user has selected invitees from their address book, the user is prompted to enter new invitees.

If the user elects to enter new invitees, then the user is prompted to enter the name and e-mail address of the new invitee. After the user has entered the name and e-mail address of a new invitee, the user is prompted to save the name and address of the new invitee in their address book. Once the list of invitees is selected, each invitee is linked to the invitation in the invitation database.

Once the user has finished entering the invitees, the list of invitees is displayed for the user. In an embodiment, a checkbox is placed next to each name on the list of invitees to indicate individuals whose physical address information has been entered and who may therefore receive an invitation by traditional mail. The user can check these additional checkboxes to send paper invitations to specific individuals.

In another embodiment, an additional checkbox is placed next to each name on the list of invites to indicate whether the user wishes to be notified by e-mail when that person responds. If the user checks the e-mail notification checkbox, then the user is notified, once the checked individual responds.

Once the invitations and invitee have been selected, the user is queried as to whether they want photographs and other content about the event to be postable to the invitation server. If the user indicates that they want photographs and other content to be postable, then the invitation server allocates the necessary resources. If the user indicates that they want content to be postable, then the user is prompted to be notified by e-mail whenever content is posted.

In an additional embodiment, the user is prompted to make any event content pages password protected. If the user responds that they wish to make the content pages password protected, then a password is generated so that only invitees can have access. Alternatively, access will be available to anyone who can access the remote communication interface.

Once the user has finished verifying the invitee list, the user is returned to the main screen where they are presented with their initial options again.

View Previous Event Photographs and Information

If from the main menu the user chooses to view previous event photographs and information, then the user is provided with a previous event information page. The previous event information page contains the title and date of each previous event as well as the host of the previous event. The user can sort the events in chronological order by the name of the host, by location, by the type of event, or by a combination of these attributes.

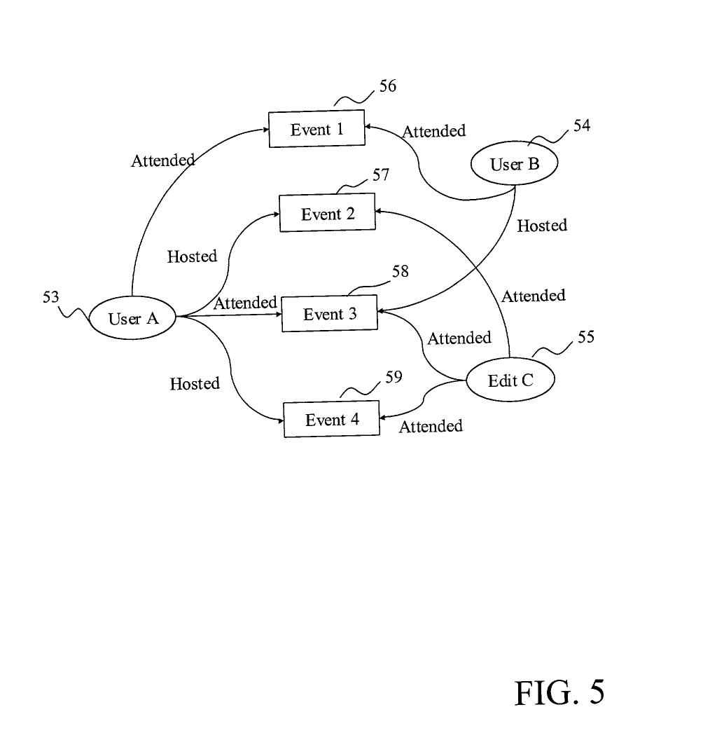

As can be seen from FIG. 5, the user is presented with a different list depending on which events they have hosted and been invited to. A user may have been the host of some events and not of others. As shown in FIG. 5, user A (53), attended event 1 (56) and event 3 (58), but hosted event 2 (57), and event 4 (59). User B (54) attended event 1 (56), and hosted event 3 (58). User C (55) attended event 2 (57), event 3 (58), and event 4(59), but did not host any events.

The user is given different access rights to event content depending on whether the user was host of the event. If the user was the host of the previous event, then the user has the ability to modify the parameters of information available about the previous event as well as the users to whom the information about the previous event will be made available. The host of the previous event is also prompted to modify the attributes of how the content is displayed to the invitees or other viewers. For example, the host may change the color of the background, add borders to posted photographs, and change the font characteristics of any posted text.

If the user was the host of the previous event, the user can also delete the previous event from their event history. In an additional embodiment of the present invention, the user can also delete previous event information from the history of all of the invitees of the previous event.

If the user was not the host of the previous event, then the user only has the access provided to them by the host of the previous event. In an embodiment of the present invention, a user may view any photographs posted to the event by attendees or the host of the previous event. In an additional embodiment of the present invention, the user may comment upon photographs posted in a comment area provided to them.

In an additional embodiment, the user is prompted to download any photographs, audio or video to be shown to other invitees or the host of the prior event. After a user uploads content about the event to the invitation server, if the host of the party allows for this functionality from this user, the user is prompted to send an e-mail to other party invitees informing them of the updated content. In an embodiment, if the user elects to send out an e-mail to other party invitees, the e-mail contains a link which allows the recipients of the e-mail to go straight to the event content screen to view the new content posted by the user.

A user is also prompted to order copies of photographs that others have posted about the event. In an embodiment, if the user elects to order a photograph that another has posted, the user is prompted to either download a high resolution copy of the image or to have the image printed out and sent to them. If the user elects to have a printout sent to them, then the image is sent to a printer for printing, along with information to convey the printed photograph to the physical address of the user. The user may be billed to a credit card on file, or may be prompted to pay at the time they order the photograph.

In an embodiment, a photograph or other piece of media, such as an audio or video file, is stored by the invitation server and a link established in a database between the media file and the event that the media is connected with. Any comments about a media file are linked in a database to the media file to which the comments refer. Therefore, when later visitors submit a request to see photographs and information about an event, the invitation server builds a page including the media element and any comments about the media element.

View and Modify Current Event Information

If the user selects “view and modify current event information” from the main menu, the user is presented with a list of events that have not yet transpired. The user is prompted to select one of the events to view and modify. Once the invitation server has received a selection of a current event to view and modify, the server provides the user with a screen showing the attributes of the current event. In an embodiment, the attribute screen displays the identity of each of the invitees and whether that invitee has responded in the affirmative, the negative, or has not responded, as well as any answers provided by that invitee to any questions posted on the invitation.

The screen containing the event attribute information allows the user to modify the event information such as the date and time of the event, and the title of the event. The user is also prompted to modify the text and attributes of the invitation, and the text and attributes of the reminder notice. Finally, the user is prompted to edit the list of the invitees. If the user elects to edit the list of invitees, the user may add new invitees as discussed above.

If the user modifies information on an event for which invitations have not been sent out yet, then the invitations are modified before they are sent out. Likewise, if the invitations have not yet been sent out, the user is prompted to delete invitees by checking off a checkbox on the list of invitees and pressing a delete button.

If the user modifies event information for an event for which invitations have already been sent out, and the modification is to an attribute that may impact those who have already responded, the system modifies the invitation and reforwards the invitation to the invitees and asks them to respond again. Once the user has viewed and modified a particular event, the user indicates that they are finished by selecting a “finished” button on the screen. The user is then prompted to view or modify a different current event by choosing from the current event list screen. Once the user indicates that they are finished viewing and modifying current event information, the user is returned to the main menu.

Gift Registry

If the user selects to set up or edit a gift registry from the main menu, the user is provided with a gift registry set-up screen. In an embodiment, the registry set-up screen contains links to the registry set-up screens for third party registry providers. Once a user selects a particular third party registry provider, the invitation server saves a link to the third party registry party provider containing the name the user provided to the third party registry. The link can later be presented to invitees who want to get gifts for the host. In an embodiment, a registry can be linked with a specific event, so that when the invitees view a specific event, the invitees are prompted to select a gift for the host or the person for whom the event was organized from a specific registry.

In an additional embodiment, the system can display banner advertisements on the screen when the invitees reply. The user is given the option of turning off the banner advertisements for the invitees. Additionally, banner advertisements relating to the subject matter of the event may be shown to the event host while the event host is organizing the event.

The Recipient's Response

Once the time to send invitations to invitees has arrived, the invitation server electronically mails invitations to each of the invitees. In an additional embodiment of the present invention, the host may designate some of the invitees to receive traditional mailed invitations. For the sake of the example embodiment below, the recipient will be presumed to have received an electronic invitation, although an invitee with a computer who receives a traditional invitation, may enter a string of text from the invitation into their web browser to reach the point that an electronic invitation recipient is at when they click the link in their invitation.

When an invitee receives an electronic invitation, the invitee's Internet browser either automatically, or after the invitee clicks on a link in an e-mail, contacts the invitation server. The invitation server, as shown in FIG. 5, checks the log-in information provided with the link from the invitation sent to the invitee to ensure that they are the proper recipient of the invitation.

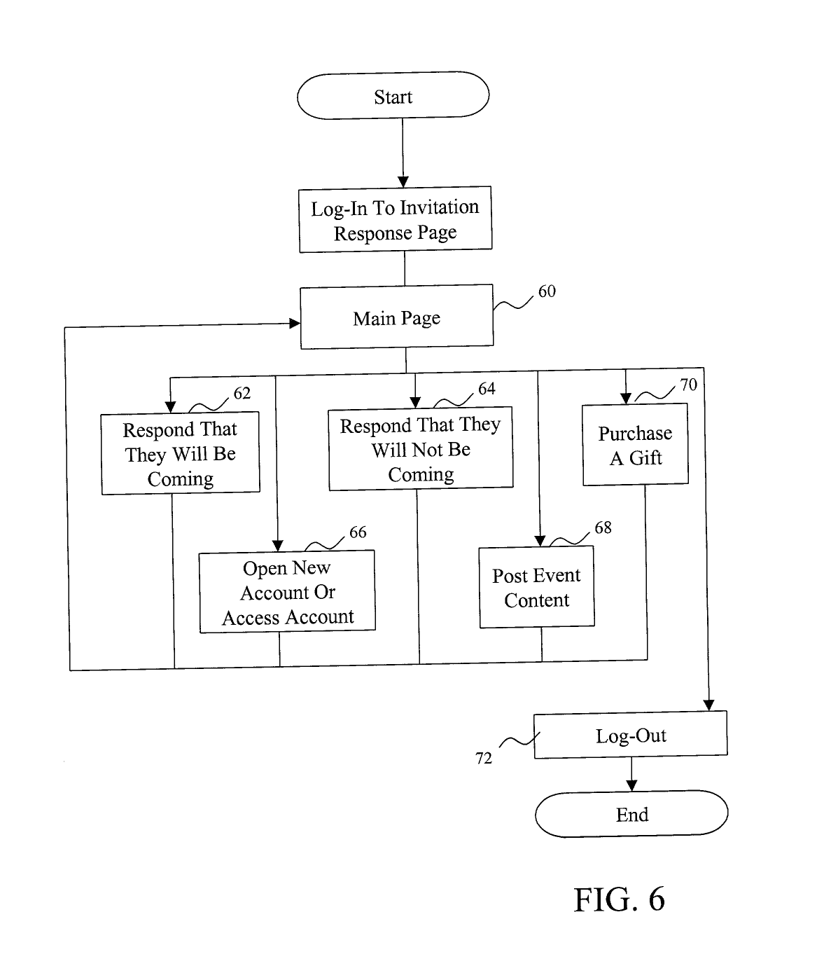

If the link used by the invitee is accepted, then the invitee is presented with a main menu 60, as shown in FIG. 6. On the main menu, the invitee will be prompted to respond that they will be attending the event 62, respond that they will not be attending the event 64, open an account of their own if they do not have one or access their account 66, post event related content 68, purchase a gift for the person on the invitation 70, and to exit the system. In an additional embodiment of the present invention, if the event has passed and the user is using the link from the invitation to view the site, the user will be shown information about the event, as well as any content posted by either the host or other invitees. In an additional embodiment, the main menu displays the identity of each other invitee and indicates whether or not the invitee has responded in the affirmative, the negative, or has not responded.

If the user responds that they will be attending the event, then the user is shown a reminder date selected by the host, if there is one. The user is prompted to accept the default reminder date or enter a new one. Alternatively, the user is prompted to prevent the reminder from being sent. Additionally, the user is prompted to enter the number of people in their party and to send a message to the host.

If the host has asked questions on the invitation, the user is prompted to answer them. For example, if the event type is a potluck, the invitee who has indicated they will be attending, is prompted to select a menu entree from a list. After the invitee selects a menu entree, that menu entree will be taken off of the list for selection by other invitees who respond that they will be attending. Once the user has finished entering response information, the user is returned to the main menu.

If a user indicates that they will not be attending the event, then the user is prompted to provide comments to the host indicating why not. Once the user has finished entering response information the user is returned to the main menu.

Regardless of whether the invitee indicates that they will be coming, the invitee is prompted to purchase a gift for either the host of the event, or a person for whom the event is being organized. If the user elects to purchase a gift for either the host or the person for whom the event is organized, the invitee is taken to a registry screen if available, or prompted to select gifts related to the event type.

In an additional embodiment of the present invention, banner advertisements may be displayed on the screen. The banner advertisements may be selected by the type of event that the user is viewing. The banner advertisements may also be customized based upon the known characteristics at least one of the host, the person for whom the event is being coordinated, and the invitee.

If the user elects to open a new account or enter their already existing account, then the user is forwarded to the log-in screen encountered by an event host, described above. If the user elects to view and post content related to an event, then the user is prompted to view and post content in the same manner discussed above for an event host. The user is also prompted to comment on content posted by others, as described above.

Many tourism related activities can be enhanced by an event-based community. For example, a group of people may be going on the same cruise or tour and would like to meet prior to the trip, and keep in touch after the trip. These people may know each other already, for example, if the people are an extended family, a group of friends, or if the event is a corporate function. Alternatively, the people may not know each other, but belong to a common institution such as a senior citizen club or celebrity fan club. Alternatively, the people might be attending a special seminar as part of a cruise or tour.

Additionally, event-based communities can enhance the experience of a cruise or tour for people who have just met online and are going on the same cruise or tour. An online travel agency, cruise line, or tour company may arrange for its customers to meet online prior to going on a cruise or tour and to help them keep in touch after the trip. For example, a travel agency, cruise line, or tour company web site may help its customers organize an event-based community for a particular cruise or tour. The organizer may do this by entering all of the customers into an address book and inviting them all to the event.

At the end of the cruise or tour, the passengers can upload photos onto the invitation site and participate in discussions with the other passengers. The same passengers can also view and download photos that others, including the tour organizers have uploaded. In an embodiment, the invitation site may charge a small fee for printing and mailing selected photos to a passenger. Alternatively, the web site may charge a fee for each electronic file download.

The preceding description has been presented with reference to the presently preferred embodiments of the invention shown in the drawings. Workers skilled in the art and technology to which this invention pertains will appreciate that alterations and changes in the described structures can be practiced without departing from the spirit, principles and scope of this invention.

Accordingly, the foregoing description should not be read as pertaining only to the precise structure described, but rather should be read consistent with, and as support for the following claims.

What is claimed is:

1. A method for producing electronic invitations and for storing event information for a plurality of users comprising the steps of:
receiving from a first user invitation information, the invitation information including information about an event and about a plurality of recipients of the invitation;
storing invitation information in a database
sending invitation information to the plurality of recipients; and
receiving from at least one of the plurality of recipients a response to the invitation.

2. The method for producing electronic invitations of claim 1 further comprising the steps of:
receiving from a first user a question to be asked of the plurality of recipients;
sending the question to one of the plurality of recipients;
receiving a response from the one of the plurality of recipients; and
modifying the question for a remaining subset of the plurality of recipients based upon the response from the one of the plurality of recipients.

3. The method for producing electronic invitations of claim 1 further comprising the steps of:
receiving from at least one of the group consisting of the first user and at least one of the recipients a photograph corresponding to an event;
storing the photograph in a database corresponding to the event to which the photograph corresponds;
receiving a request for a event information from at least one of the group consisting of the first user and at least one of the recipients; and
sending the photograph to the at least one of the group consisting of the first user and at least one of the recipients.

4. The method of producing electronic invitations of claim 3 further comprising the steps of:
prompting at least one of the recipients to enter a comment about a photograph sent;
receiving from at least one of the recipients a comment about the photograph;
storing the comment about the photograph in a database corresponding to the photograph;
receiving a later request from another of the recipients for the photograph;
sending both the photograph and the comment to the recipient.

5. The method of producing electronic invitations of claim 3 further comprising the steps of:
sending to the first user a list of events for which the first user has made invitations or received invitations;
prompting the first user to select an event from the list of events;
receiving from the first user a selection of an event from the list of events; and
sending to the first user event information corresponding to the event selected by the first user.

6. The method of producing electronic invitations of claim 5 wherein the information corresponding to the event selected by the first user comprises at least one of the group consisting of a list of invitation recipients, photographs, and comments about photographs.

7. The method of producing electronic invitations of claim 1 further comprising the steps of:
prompting the first user to create a gift registry for the event corresponding to the invitation;
receiving from the user gift registry information for the event corresponding to the invitation; and
prompting the plurality of recipients to purchase a gift from the gift registry.

8. The method of producing electronic invitations of claim 1 further comprising the steps of:
prompting the first user to select attributes for the invitation;
receiving from the first user attributes for the invitation; and
storing the attributes for the invitation in the database.

9. The method of producing electronic invitations of claim 8 wherein the attributes comprise at least one of the group consisting of text font, text size, text color, text, background color, graphics, sound, and video.

10. The method of producing electronic invitations of claim 1 further comprising the steps of:
sending a reminder letter to recipients for which a positive response has been received;
sending an additional response request to recipients for which no response has been received.

11. The method for producing electronic invitations of claim 1 wherein the information about the event received from the first user includes the physical location of the event; and the information about the plurality of recipients includes the physical location of each of the plurality of recipients.

12. The method for producing electronic invitations of claim 11 further comprising the steps of:
generating directions from the physical location of each of the plurality of recipients to the physical location of the event; and
storing the directions in a directions database;
sending to each one of the plurality of recipients along with the invitation the directions from the physical location of each one of the plurality of recipients to the physical location of the event.

13. A system for producing electronic invitations for an event comprising:
a database coupled to a computer network for storing information about invitations, recipients, responses, and events;
a server coupled to the computer network, configured to receive event information from an event host, prepare invitations to the event, send the invitations to a plurality of recipients, and receive a response to the sent invitation from at least one of the plurality of recipients.

14. The system for producing electronic invitations for an event of claim 13 wherein the server is further configured to send a notification of an invitation to a plurality of recipients, prompt the plurality of recipients to view an invitation, and to receive requests to view an invitation from the plurality of recipients.

15. The system for producing electronic invitations for an event of claim 14 wherein the server is further configured to receive a question to be asked to the plurality of recipients along with the invitation, send the question to the plurality of recipients along with the invitation, receive a response to the question from each of the plurality of recipients, and to modify the question after receiving a response to the question from each of the plurality of recipients so that a subset of the plurality of recipients who later request to view the invitation are sent a modified question.

16. The system for producing electronic invitations for an event of claim 13 wherein the computer network is the Internet.

17. The system for producing electronic invitations for an event of claim 13 wherein the server is further configured to receive event information from at least one of the group consisting of the event host and one of the plurality of recipients, to store the event information in the database, to receive requests for event information from at least one of the group consisting of the event host and one of the plurality of recipients, to send event information to the group consisting of at least one of the plurality of recipients.

18. The system for producing electronic invitations for an event of claim 17 wherein the event information that the server is configured to receive includes at least one of the group consisting of text, photographs, audio and video.

19. The system for producing electronic invitations for an event of claim 18 wherein the server is further configured to receive event information from the host, receive a selection from the host of which of the recipients may receive event information, and to send event information only in response to requests from recipients selected by the host to receive event information.

20. A computerized method for creating event based communities comprising the steps of:
storing information about a plurality of events;
receiving a request for information about a plurality of events;
sending a list of a subset of a plurality of events in response to the request for information about a plurality of events;
receiving a request for information about at least one of the subset of the plurality of events; and
sending information about the at least one of the subset of the plurality of events requested.

21. The computerized method for creating event based communities of claim 20 wherein the storing of information about a plurality of events further comprises:
storing a list of guests invited to an event;
storing an invitation response of each of the guests invited to the event;
storing photographs received about the event; and
storing comments to photographs received about the event.

22. A computer readable medium having stored thereon a set of instructions including instructions for creating electronic invitations, the instructions, when executed by a microprocessor, cause the microprocessor to perform the steps of:
prompting an event host to enter an event type;
receiving from the event host the event type;
prompting the event host to select a date of an event;
receiving from the event host the date of the event;
prompting the event host to enter invitation text;
receiving from the event host invitation text;
prompting the event host to select invitation attributes;
receiving from the event host invitation attributes;
prompting the event host to select invitees;
receiving from the event host a selection of invitees;
sending an invitation to the selection of invitees;
receiving a response from at least one of the selection of invitees.

23. A computer readable medium having stored thereon a set of instructions including instructions for creating electronic invitations, the instructions, when executed by a microprocessor, cause the microprocessor to perform the steps of:
storing information about a plurality of events and a plurality of hosts and invitees of the events;
receiving from a user a request for information about an event;
sending to the user information about at least one of the events associated with the user;
prompting the user to enter at least one of the group consisting of text, photographs, audio and video about the at least one of the events associated with the user;
receiving from a user at least one of the group consisting of text, photographs, audio and video about the at least one of the events associated with the user;
storing the at least one of the group consisting of text, photographs, audio and video received from the user as information about the event for later sending in response to requests from other users for information about the associated event.
